(19) United States
(12) Patent Application Publication
(10) Pub. No.: US 2025/0271991 A1
(43) Pub. Date: Aug. 28, 2025

(54) COLLABORATIVE WORKSPACE APPARATUS AND SYSTEM WITH ENHANCED AUDIO TRANSCRIPTION SUPPORT

(71) Applicant: Aurora Multimedia Corp., Morganville, NJ (US)

(72) Inventor: Paul Harris, Manalapan, NJ (US)

(73) Assignee: Aurora Multimedia Corp., Morganville, NJ (US)

(21) Appl. No.: 19/207,674

(22) Filed: May 14, 2025

Related U.S. Application Data
(63) Continuation-in-part of application No. 18/886,313, filed on Sep. 16, 2024.
Application No. 18/886,313 is a continuation of application No. 18/149,738, filed on Jan. 4, 2023, now Pat. No. 12,118,206.

(51) Int. Cl. G06F 3/04886; G06F 3/01; G06F 3/147; H04R 5/04

(52) U.S. Cl. CPC G06F 3/04886; G06F 3/017; G06F 3/147; H04R 5/04

(57) ABSTRACT

An interactive workspace apparatus and system to facilitate participation and collaboration in a physical workspace. The apparatus includes a housing, at least one microphone, a speaker, and a programmable processor. The housing includes a base platform and a display panel extending upwardly from the front edge of the base platform at a fixed acute angle. The microphone is coupled to the housing and configured to capture sound from an audio source and convert the sound into an audio signal. The speaker is coupled to the housing and configured to receive at least one audio signal and emit an audio output in response thereto. The programmable processor is disposed within the housing and configured to convert the audio signal into text and to display the text on the display screen.

### CROSS REFERENCES AND RELATED SUBJECT MATTER

This continuation-in-part application claims the benefit of priority of U.S. patent application Ser. No. 18/886,313, filed Sep. 16, 2024, which claims the benefit of priority of U.S. patent application Ser. No. 18/149,738, filed Jan. 4, 2023, the contents of which are relied upon and incorporated herein by reference in their entirety.

### TECHNICAL FIELD

The present disclosure relates generally to workspace conferencing devices. More particularly, the present disclosure relates to an interactive apparatus and system to facilitate workspace participation and collaboration.

### BACKGROUND

The recent prevalence of remote work systems has increased an appreciation and desire for in-person, face-to-face collaboration. Indeed, in-person work environments tend to provide better opportunities to socialize and connect to company culture, be exposed to informal learning opportunities, network, and access tools and physical resources. In-person work environments, however, struggle to provide the same quality of technological collaboration, integration, and ease of use as remote work systems.

Accordingly, what is needed is an interactive workspace apparatus and system that promotes participation and collaboration among individual participants of a group. Also, what is needed is an interactive workspace system that includes multiple interconnected, customizable interactive workspace apparatuses, where each interactive workspace apparatus corresponds to one participant of the group. Beneficially, the interactive workspace apparatus would enable the participant to speak at a normal volume to communicate with another participant and/or the group.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

An aspect of an example embodiment in the present disclosure is an interactive workspace apparatus to facilitate participation and collaboration in a physical workspace. The apparatus includes a housing, at least one microphone, a speaker, and a programmable processor. The housing includes a base platform extending from a front edge to a back edge along a horizontal axis and a display panel extending upwardly from the front edge towards the back edge at a fixed acute angle. The display panel includes a display screen configured to receive user input.

One or more microphones is coupled to the housing. Each microphone is configured to capture sound from an audio source and convert the sound into an audio signal. The speaker is coupled to the housing and configured to receive at least one audio signal and to emit an audio output in response thereto. The programmable processor is disposed within the housing and operably coupled to at least one memory device. The programmable processor is configured to convert the audio signal into text and to display the text on the display screen.

In some embodiments, the programmable processor is configured to transmit the text to another interconnected controller device. In certain embodiments, the programmable processor is configured to tag the text with a timestamp and/or tag the text with an identity of the audio source. In some embodiments, the programmable processor is configured to combine the text corresponding to multiple audio sources into a single unified document and display the document on the display screen.

In some embodiments, the programmable processor is configured to store the text for later recall. This feature may facilitate real-time accessibility and record-keeping of spoken interactions in a workspace environment.

In certain embodiments, the programmable processor is configured to trigger at least one predetermined operational setting of a camera disposed in the physical workspace in response to the text. In some embodiments, the programmable processor is configured to translate the text into a selected language to produce translated text. The programmable processor may be further configured to display the translated text on the display screen.

In some embodiments, the programmable processor is configured to convert the translated text into at least one audio signal such that the audio output corresponds to the translated text.

According to another aspect of the present disclosure, an interactive workspace system to facilitate participation and collaboration in a physical workspace is presented. The interactive workspace system includes a first interactive workspace apparatus disposed in the physical workspace at a first location and a second interactive workspace apparatus interconnected to the first interactive workspace apparatus and disposed in the physical workspace at a second location. The first interactive workspace apparatus and the second interactive workspace apparatus have a mix-minus configuration such that the at least one audio signal is automatically adjusted in response to a distance between the first location and the second location.

Each of the interactive workspace apparatuses includes a housing having a base platform and a display panel. The base platform extends from a front edge to a back edge along a horizontal axis and the display panel extends upwardly from the front edge towards the back edge at a fixed acute angle. The display panel includes a display screen configured to receive user input.

The first and the second interactive workspace apparatuses further include at least one microphone, a speaker, and a programmable processor. The microphone is coupled to the housing and configured to capture sound from an audio source and to convert the sound into one or more audio signals. The speaker is coupled to the housing and configured to receive the audio signal and to emit an audio output in response thereto. The audio output is amplified based on a distance between the first location and the second location in the mix-minus configuration. The programmable processor is disposed within the housing and operably coupled to at least one memory device. The programmable processor is configured to automatically adjust the amplification based on the mix-minus configuration. The programmable processor is further configured to convert the audio signal into text and to display the text on the display screen.

In some embodiments, the interactive workspace apparatuses include an internal web server configured to display a configuration page on the display screen. The configuration page may be configured to receive user input to customize a look and feel of the apparatus.

In some embodiments, the programmable processor is configured to tag the text with a timestamp and/or an identity of the audio source. In some embodiments, the programmable processor is configured to combine the text corresponding to multiple audio sources into a single unified document and display the single unified document on the display screen. In certain embodiments, the programmable processor is configured to store the single unified document for later recall.

In some embodiments, the programmable processor is configured to trigger at least one predetermined operational setting of the first and/or second interactive workspace apparatus based on the text. In some embodiments, the programmable processor is configured to trigger at least one predetermined operational setting of a camera disposed in the physical workspace in response to the text and/or the timestamp.

In some embodiments, the programmable processor is configured to translate the text into a selected language to produce translated text. In certain embodiments, the programmable processor is further configured to display the translated text on the display screen. In some embodiments, the programmable processor is configured to convert the translated text into one or more audio signals such that the audio output corresponds to the translated text.

In some embodiments, the programmable processor is configured to automatically determine a distance between the first location and the second location and to automatically configure each of the first interactive workspace apparatus and the second interactive workspace apparatus according to the mix-minus configuration. In certain embodiments, the programmable processor is configured to dynamically reconfigure the first interactive workspace apparatus and the second interactive workspace apparatus in response to a change in the distance.

The present disclosure addresses at least one of the disadvantages discussed above with respect to known workspace solutions. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1 is a high-level block diagram showing one example of a computing system in which a system and method in accordance with the invention may be implemented;

FIG. 2 is a front perspective view of a representative controller device in accordance with the disclosure;

FIG. 3 is a rear perspective view of the controller device of FIG. 2;

FIG. 4A is a front view of one embodiment of a controller device in accordance with the disclosure;

FIG. 4B is a front view of another embodiment of a controller device in accordance with the disclosure;

FIG. 5 is a diagrammatic front view of a representative physical workspace having a wall-mounted controller device in accordance with certain embodiments;

FIG. 6 is a diagrammatic top view of a representative physical workspace including an example interactive workspace integration system in accordance with the disclosure;

FIG. 7A is diagrammatic top view of a representative interactive workspace integration system illustrating microphone pickup patterns with a single user in accordance with some embodiments;

FIG. 7B is diagrammatic top view of a representative interactive workspace integration system illustrating microphone pickup patterns with two users in accordance with some embodiments;

FIG. 7C is diagrammatic top view of a representative interactive workspace integration system illustrating microphone pickup patterns with four users in accordance with some embodiments;

FIG. 8 is a front view of a representative controller device and an example mobile device illustrating wireless communication therebetween in accordance with certain embodiments;

FIG. 9 is a front view of a representative controller device illustrating a configurable user control interface in accordance with some embodiments;

FIG. 10 is a front view of a representative controller device illustrating an example user control interface providing a raise hand function in accordance with some embodiments;

FIG. 11 is a front view of a representative controller device illustrating an example user control interface providing a vote function in accordance with some embodiments;

FIG. 12 is a front perspective view of a representative controller device and audio output device illustrating an example user control interface providing an assistive hearing function in accordance with some embodiments;

FIG. 13A is a diagrammatic top view of representative controller devices illustrating peer to peer communication in accordance with some embodiments;

FIG. 13B is a diagrammatic top view of representative controller devices illustrating peer to hub communication in accordance with some embodiments;

FIG. 14 is a rear perspective view of a representative controller device having multiple input ports configured to receive various peripheral devices in accordance with some embodiments of the disclosure;

FIG. 15 is a diagrammatic plan view of a representative controller device connected to various peripheral devices in accordance with certain embodiments;

FIG. 16A is a front perspective view of one example of a subwoofer device in communication with at least one controller device in accordance with some embodiments of the disclosure;

FIG. 16B is a side perspective view of the subwoofer device of FIG. 16A;

FIG. 17 is a diagrammatic top view of multiple representative controller devices and an example subwoofer device in accordance with some embodiments;

FIG. 18 is a diagrammatic top view of multiple representative controller devices illustrating peer to peer communication in a mix-minus system in accordance with some embodiments of the present disclosure; and

FIG. 19 is a diagrammatic top view of a representative controller device having multiple microphones configured to filter the sound via an angular beamforming technique in accordance with some embodiments of the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

As discussed above, interconnected technological systems promote virtual collaboration by enabling multiple participants in various locations to meet virtually while simultaneously sharing documents, accessing the internet, and utilizing assistive technologies. These benefits are largely unavailable to participants in physical workspace environments. The present disclosure addresses these and other issues.

As used herein, the term “media signal” refers to any audio signal, video signal, or combination thereof.

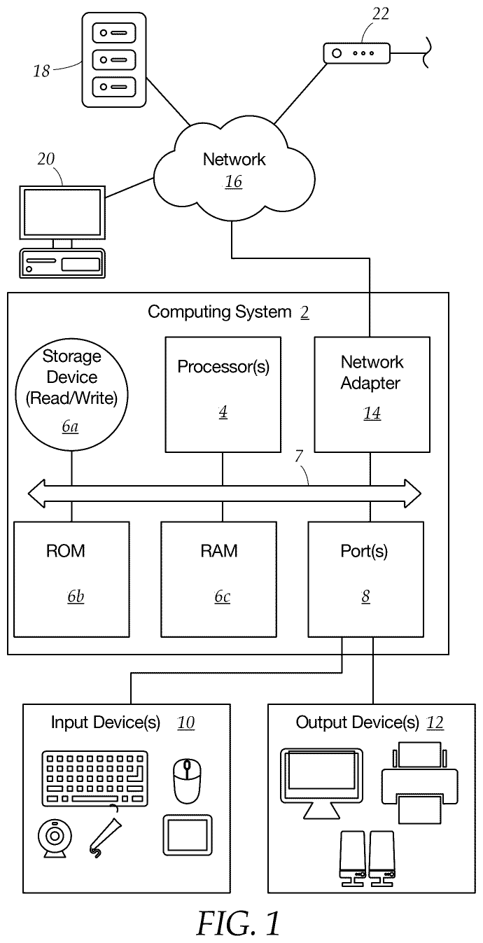

Referring to FIG. 1, one example of a computing system 2 is illustrated. The computing system 2 is presented to show one example of an environment where a system and method in accordance with the invention may be implemented. The computing system 2 may be embodied as a mobile device such as a smart phone or tablet, a desktop computer, a workstation, a server, or the like. The computing system 2 is presented by way of example and is not intended to be limiting. Indeed, the systems and methods disclosed herein may be applicable to a wide variety of different computing systems in addition to the computing system 2 shown. The systems and methods disclosed herein may also potentially be distributed across multiple computing systems 2.

As shown, the computing system 2 includes at least one processor 4 and may include more than one processor 4. The processor 4 may be operably connected to a memory 6a-c. The memory 6a-c may include one or more non-volatile storage devices such as hard drives 6a, solid state drives 6a, CD-ROM drives 6a, DVD-ROM drives 6a, tape drives 6a, or the like. The memory 6a-c may also include non-volatile memory such as a read-only memory 6b (e.g., ROM, EPROM, EEPROM, and/or Flash ROM) or volatile memory such as a random access memory 6c (RAM or operational memory). A bus 7, or plurality of buses 7, may interconnect the processor 4, memory devices 6a-c, and other devices to enable data and/or instructions to pass therebetween.

To enable communication with external systems or devices, the computing system 2 may include one or more ports 8. Such ports 8 may be embodied as wired ports 8 (e.g., USB ports, serial ports, Firewire ports, SCSI ports, parallel ports, etc.) or wireless ports 8 (e.g., Bluetooth, IrDA, etc.). The ports 8 may enable communication with one or more input devices 10 (e.g., keyboards, mice, touchscreens, cameras, microphones, scanners, storage devices, etc.) and output devices 12 (e.g., displays, monitors, speakers, printers, storage devices, etc.). The ports 8 may also enable communication with other computing systems 2.

In certain embodiments, the computing system 2 includes a wired or wireless network adapter 14 to connect the computing system 2 to a network 16, such as a LAN, WAN, Wi-Fi, or the Internet. Such a network 16 may enable the computing system 2 to connect to one or more servers 18, workstations or personal computers 20, mobile computing devices, or other devices. The network 16 may also enable the computing system 2 to connect to another network by way of a router 22 or other device 22. Such a router 22 may allow the computing system 2 to communicate with servers, workstations, personal computers, or other devices located on different networks.

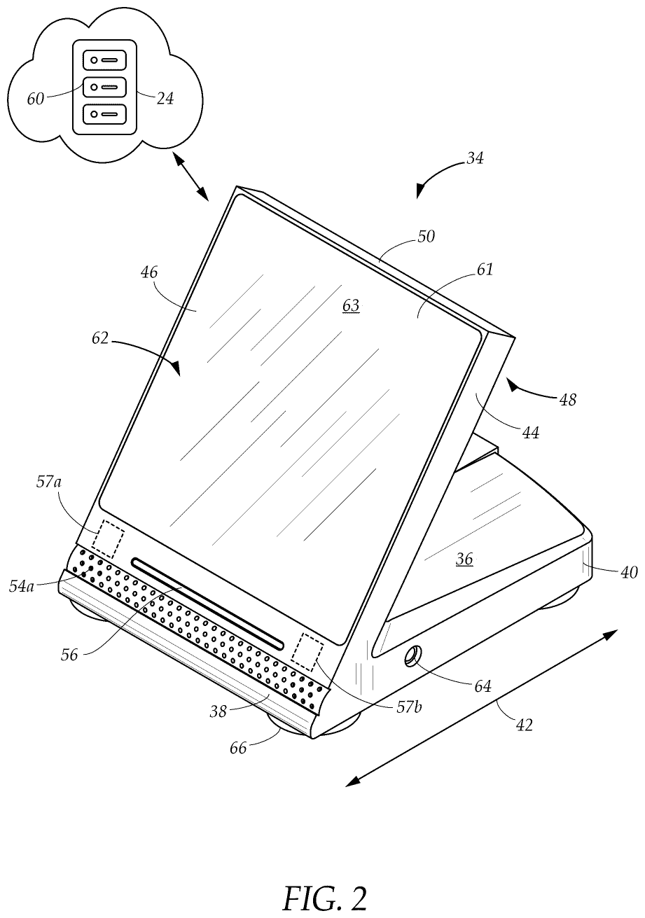

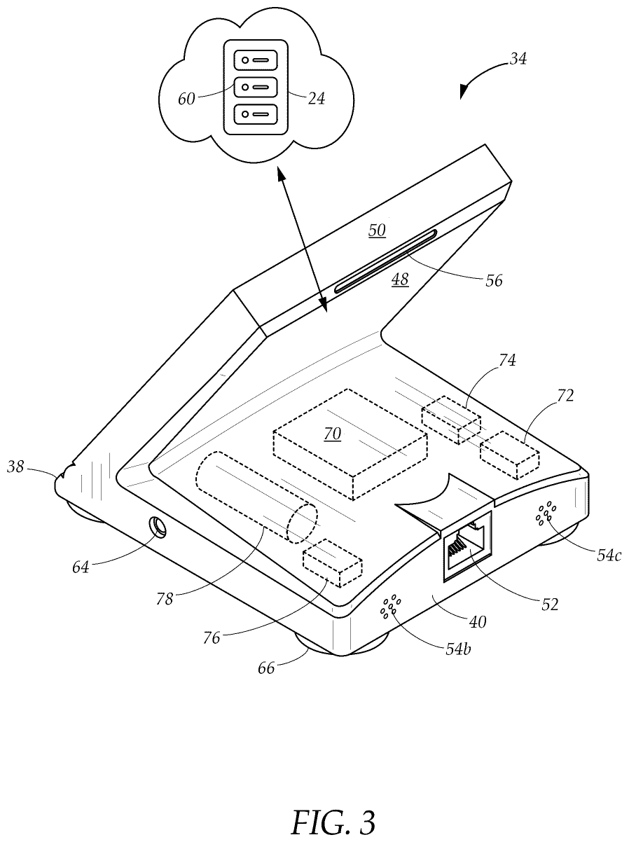

Referring now to FIGS. 2 and 3, some embodiments presented herein provide an interactive workspace integration system for integrating a physical workspace having one or more electronic devices with a virtual workspace. In some embodiments, the interactive workspace integration system includes multiple controller devices 34 disposed in the physical workspace, where each of the controller devices 34 is interconnected with each other controller device 34. Each of the controller devices 34 is also configured to interface with a virtual workspace. In some embodiments, the virtual workspace may include any digital technology that enables work and/or collaboration from multiple remote locations. For example, the virtual workspace may include digital technologies such as Zoom, Teams, WebEx, or the like.

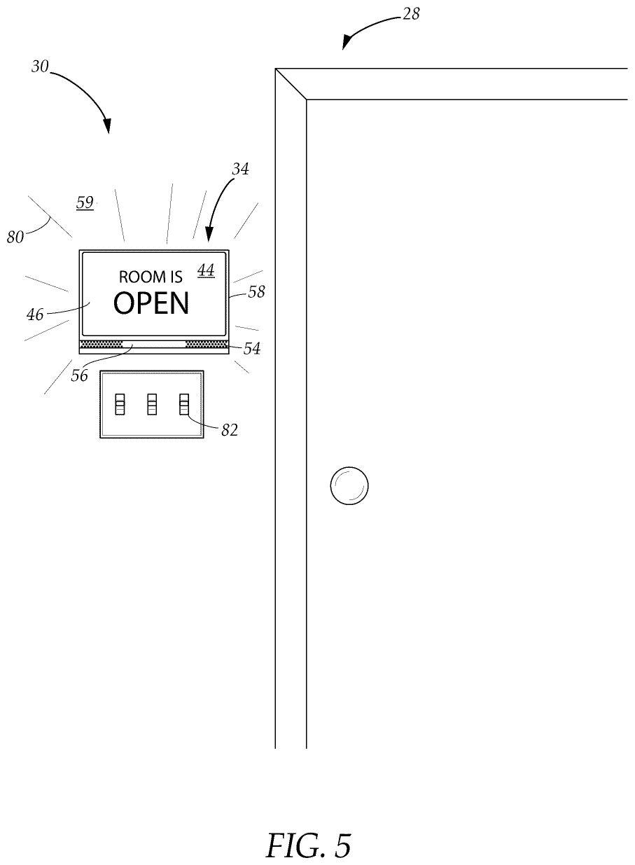

In some embodiments, each controller device 34 may correspond to exactly one user. In other embodiments, a controller device 34 may correspond to more than one user. As depicted in more detail with reference to FIG. 5 below while still referring to FIGS. 2 and 3, the physical workspace 28 may include one or more electronic devices 82 such as a stereo, a camera, a computer, a CD/DVD player, a monitor or screen, a light, a speaker, or any other electronic device, for example. The controller device 34 may be configured to control one or more of the electronic devices 82 in the physical workspace.

In some embodiments, each controller device 34 may include a programmable processor 60 operably connected to one or more memory devices. Some embodiments of the programmable processor 60 may include a Linux™ operating system. In other embodiments, the programmable processor 60 may incorporate a Unix-based operating system, a Windows-based operating system, a Mac-based operating system, a real-time operating system, and/or any other suitable operating system. In some embodiments, the programmable processor 60 may be local to the controller device 34.

In other embodiments, the programmable processor 60 may be remote to the controller device 34. In one embodiment, for example, the programmable processor 60 may include a remote server 24, such as a cloud server, a mobile device, or any other suitable remote computing device. Processing-intensive tasks such as video processing may be performed by the remote server 24, which may have additional processing resources and capabilities compared to the controller device 34.

For example, in some embodiments, the remote server 24 may include a video graphics engine having a high-definition streaming decoder configured to receive and decode video files. In these and other embodiments, the controller device 34 may maintain connectivity with the remote server 24 by way of an appropriate wired or wireless communication technology, such as a Wi-Fi connection, cellular data connection, or the like. In some embodiments, the controller device 34 may communicate with the remote server 24 by wireless transmission methods such as Wi-Fi, near-field communication (“NFC”), or Bluetooth®. In other embodiments, a video graphics engine and/or high-definition streaming decoder may be included in a programmable processor 60 local to the controller device 34.

In some embodiments, the controller device 34 includes an internal web server 70 to enable a user to configure the controller device 34. In some embodiments, as shown in FIGS. 2 and 3, the controller device 34 may include a base platform 36 and a display panel 44. Some embodiments of the base platform 36 may include the internal web server 70. The internal web server 70 may display a configuration page on the display panel 44. In some embodiments, the display panel 44 may include a user control interface 62 to enable a user to input information to configure the controller device 34.

The base platform 36 may be substantially planar and may extend from a front edge 38 to a back edge 40 along a horizontal axis 42. In some embodiments, the base platform 36 may include a network port 52, such as an ethernet port to facilitate communication with other devices on a shared network. In some embodiments, the base platform 36 may include various ports to enable communication with remote devices, such as the remote server 24. In some embodiments, for example, the base platform 36 may include a Wi-Fi port 72, a Bluetooth port 74, and/or an NFC port 76. Some embodiments of the base platform 36 may also include a power source 78, such as a battery or power cord.

In some embodiments, the base platform 36 may include one or more microphones 54a-c integrated with the base platform 36. The microphone 54a-c may be a multi-directional microphone, an omnidirectional microphone, or any other suitable microphone known to those in the art. In some embodiments, the microphone 54a-c is a digital microphone. In some embodiments, the microphone 54a-c is a micro-electromechanical systems (MEMS) microphone. In some embodiments, the microphone 54a-c may include a smart-amplifier speaker.

In some embodiments, at least one microphone 54a-c is configured to work together with another remotely-located microphone (not shown) in a process called “beamforming” to enhance audio capture from a specific direction while minimizing noise from other angles. The microphone 54a-c may include a multi-directional microphone 54a-c, an omnidirectional microphone 54a-c, and/or any other suitable microphone 54a-c configured to, with a remotely-located microphone (not shown), create a beamform.

In some embodiments, as shown in FIGS. 2 and 3, an array of microphones 54a-c is distributed across one or more surfaces of the base platform 36 in a linear, circular, spherical, or other desired arrangement. In one embodiment, one or more microphones 54a is integrated with the front edge 38 of the base platform 36 and two microphones 54b, 54c are integrated with a back edge 40 of the base platform 36 at disparate locations.

In another embodiment, the controller device 34 includes six (6) microphones 54a-c: two (2) directional microphones 54a-c and one (1) omnidirectional microphone 54a-c distributed along a top portion of the display panel 106, where the two (2) directional microphones 54a-c are ported in an XY configuration; two (2) omnidirectional microphones 54a-c distributed along the back surface 48 of the display panel 106 to cancel audio output from an integrated speaker (not shown); and one (1) microphone 54a-c disposed on top of the base platform 36 and configured to capture surrounding noise and/or provide echo and/or noise cancellation.

In these and other embodiments, each microphone 54a-c is configured to capture sound waves arriving from different directions at slightly different times due to the physical spacing between them. In some embodiments, a beamforming algorithm is used to calculate these time differences and apply a delay or phase shift to align the signals from a desired direction. In this manner, such signals may combine constructively, thereby strengthening the signal. Signals from other directions may remain misaligned and interfere destructively, thereby effectively reducing background noise. In some embodiments, the beamforming algorithm is an adaptive algorithm configured to continuously adjust the beamform in real-time in response to a moving sound source.

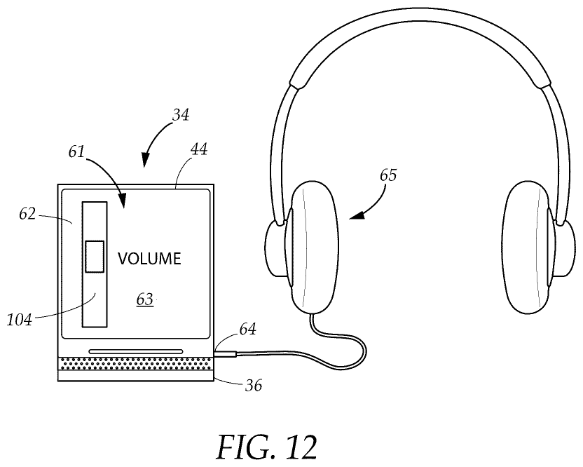

Some embodiments of the base platform 36 may include an audio port 64 to receive an audio output device 65 (shown in FIG. 12), such as a headphone, earphone, speaker, or the like. In some embodiments, the audio output device 65 may enhance the audio signals received through the audio port 64. For example, in some embodiments, the audio output device 65 may provide audio amplification, language translation, or other audio enhancement.

In some embodiments, a bottom surface of the base platform 36 may include a stabilizing feature 66, material, or texture to increase stability of the controller device 34 relative to another smooth surface, such as a desk or tabletop. The stabilizing feature 66 may include, for example, one or more feet or panels comprising rubber, felt, or any other suitable material or element coupled to or integrated with the base platform 36. In some embodiments, the stabilizing feature 66 may be monolithically formed as a single unit with the base platform 36

The display panel 44 may extend at an angle from the front edge 38 of the base platform 36 such that an acute angle is formed between the display panel 44 and the base platform 36. In this manner, a front surface 46 of the display panel 44 may be tilted upwards toward the user, thereby optimizing the user's view of the display panel 44 as well as facilitating user interaction with the display panel 44, such as receiving user input. In some embodiments, the base platform 36 may be coupled to the display panel 44 via one or more hinges, screws, nails, rivets, or any other suitable mechanical fastener. In other embodiments, the base platform 36 and the display panel 44 may be monolithically formed as a single unit. In some embodiments, the base platform 36 and/or display panel 44 may be molded from a thermoplastic polymer such as acrylonitrile butadiene styrene (ABS), polyamide, polycarbonate, polyphenylene ether (PPE), combinations thereof, or the like.

In some embodiments, the controller device 34 may be substantially compact such that the controller device 34 may be handheld and/or freestanding in a small personal workspace. For example, in one embodiment, the base platform 36 may include a square-shaped platform having dimensions of approximately four (4) inches on each side. The length from the front edge 38 to the back edge 40 may thus be approximately four (4) inches. Of course, the base platform 36 may include any suitable regular or irregular shape having any suitable dimensions.

In some embodiments, the display panel 44 may extend at an acute angle from the front edge 38 of the base platform 36 towards the back edge 40 of the base platform 36 such that the display panel 44 is tilted upwards towards the user. Some embodiments of the display panel 44 may include a front surface 46, a back surface 48, a top edge 50, and a status bar 56. In some embodiments, the display panel 44 may include a shape and/or dimensions substantially matching those of the base platform 36. In some embodiments, the display panel 44 may include a square shape having dimensions less than approximately four (4) inches on each side. Some embodiments may include a three-dimensional structure that does not exceed four inches in any direction including length, width, and height. In other embodiments, the display panel 44 may include any regular or irregular shape having any suitable dimensions. In certain embodiments, a depth of the display panel 44 may be less than or equal to a depth of the base platform 36.

In some embodiments, the display panel 44 may include a display screen 61 to display the user control interface 62 to the user. In some embodiments, the display screen 61 may include a touchscreen 63 to display the user control interface 62 and receive user input in the form of touch input. In some embodiments, the display screen 61 or touchscreen 63 may be coupled to or integrated with the display panel 44 via a press fit, an adhesive and/or any suitable fastening device. In some embodiments, the touchscreen 63 may include a resistive or capacitive touchscreen 63. Some embodiments may include a liquid crystal display (LCD), organic light-emitting diode (OLED), holographic touch display, or other suitable touchscreen 63, or touch display, configured to receive and display touch input from the user. In certain embodiments, the touchscreen 63 may include a square shape, a rectangular shape, or any other suitable shape.

In some embodiments, the programmable processor 60 is configured to convert one or more audio signals into text and to display the text on the display panel 44 and/or display screen 61. In some embodiments, the programmable processor 60 is configured to transmit the text to another interconnected controller device 34 or other suitable device.

In certain embodiments, the programmable processor 60 is configured to tag the text with a timestamp and/or identity of the audio source. In some embodiments, the programmable processor 60 is configured to combine the text corresponding to multiple audio sources into a single unified document and display the document on the display screen 44.

In some embodiments, the programmable processor is configured to store the text for later recall. This feature may facilitate real-time accessibility and record-keeping of spoken interactions in a workspace environment.

In some embodiments, the front surface 46 of the display panel 44 may include the status bar 56. In other embodiments, the status bar 56 may be coupled to or integrated with the top edge 50 and/or the back surface 48 to facilitate visibility by other users. In other embodiments, the display panel 44 may include a status bar 56 on the front surface and a status bar 56 integrated with the top edge 50 and/or the back surface 48 for facilitating visibility of a status in the front and the rear of the controller device 34. In some embodiments, the status bar 56 may be included on the base platform 36. Some embodiments of the status bar 56 may include one or more light-emitting diodes (LEDs) or other light source configured to selectively illuminate continuously or intermittently in response to user input. In some embodiments, the status bar 56 may indicate whether the multi-directional microphone 54a-c is powered on. In some embodiments, the status bar 56 may blink in response to user input to request the floor, for example.

In some embodiments, various sensors may be integrated into or coupled to the controller device 34 to gather information with respect to the surrounding environment. Sensors 57a, 57b may include, for example, a proximity sensor, an ambient light sensor, a motion sensor, a location sensor, or the like. Information gathered from the various sensors 57a, 57b may be processed by the programmable processor 60 to enable the controller device 34 to automatically perform a function or adjust a setting of one or more electronic devices 82 in the physical workspace 28, as shown in FIG. 5. For example, in one embodiment, light sensors 57a-b coupled to the controller device 34 may measure and/or monitor ambient light levels in the surrounding environment. In the event that the light sensors 57a-b detect low ambient light, the programmable processor 60 may automatically activate lights in the physical workspace 28, as shown in FIG. 5. In some embodiments, the programmable processor 60 may automatically present the user control interface 62 to the user to enable the user to manually adjust an electronic device 82 setting in response to the sensor 57a-b information, as shown in FIG. 5.

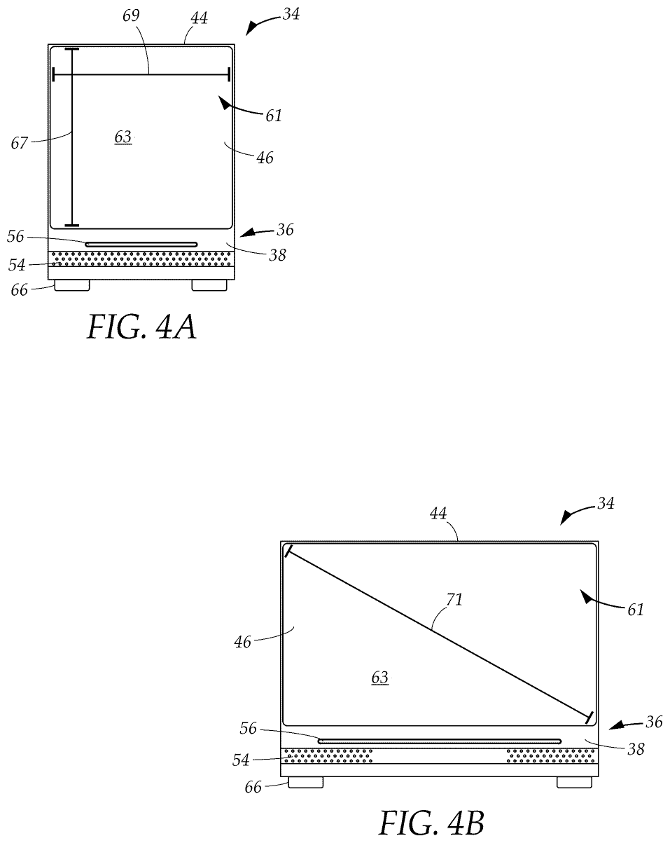

Referring now to FIGS. 4A and 4B, in some embodiments, the controller device 34 may include a display panel 44 having a display screen 61 such as a touchscreen 63. The touchscreen 63 may include dimensions less than or equal to that of the front surface 46 of the display panel 44. In one embodiment, as shown in FIG. 4A, the touchscreen 63 and the front surface 46 of the display panel 44 may be less than approximately four (4) inches square. In another embodiment, as shown in FIG. 4B, the touchscreen 63 and the front surface 46 of the display panel 44 may be less than approximately four (4) inches measured diagonally 71 from corner to corner. In certain embodiments, the touchscreen 63 may extend over a majority of the front surface 46 of the display panel 44 to maximize usable touchscreen 63 real estate. In these and other embodiments, a height 67 and/or width 69 of the touchscreen 63 may substantially match the height and/or width of the display panel 44.

In some embodiments, a height 67 and/or width 69 of the touchscreen 63 may be reduced relative to the height and/or width of the display panel 44 to provide an increased surface area for various controller device 34 components. For example, in some embodiments, the height 67 of the touchscreen 63 may be reduced relative to the height of the display panel 44 to provide increased surface area for the status bar 56 and/or multi-directional microphone 54, for example. In some embodiments, controller device 34 components may be coupled to or integrated with a front edge 38 of base platform 36. In certain embodiments, as shown, the display panel 44 may extend seamlessly from the front edge 38 of the base platform 36.

Referring now to FIG. 5, in some embodiments, the interactive workspace integration system 30 may include one or more controller devices 34 that include a wall mount 58 or other mechanical fastener to secure the controller device 34 to a wall 59 or other vertical surface. In some embodiments, the controller device 34 may be secured to an exterior or an interior of a wall 59 forming the physical workspace 28. In other embodiments, the controller device 34 may be secured to a wall 59 adjacent to the physical workspace 28.

In some embodiments, the controller device 34 may be configured to display availability of the physical workspace 28. For example, in some embodiments, the controller device 34 may include a user control interface 62 (as shown in FIG. 2) to enable an authorized user to access, schedule, or log use of the physical workspace 28. In some embodiments, the controller device 34 may display a seating arrangement in the physical workspace 28.

In some embodiments, the wall-mounted controller device 34 includes one or more microphones 54 configured to receive verbal instructions or other sound input from a user. In some embodiments, the multi-directional microphone 54 may enable a user located outside the physical workspace 28 to communicate with users inside the physical workspace 28.

Some embodiments may include a status bar 56 configured to illuminate when the multi-directional microphone 54 is on. In some embodiments, the status bar 56 may illuminate when the physical workspace 28 is occupied. In certain embodiments, the status bar 56 may illuminate in different colors to communicate different statuses. For example, the status bar 56 may illuminate in red to indicate that the physical workspace 28 is occupied, in yellow to indicate that a meeting in the physical workspace 28 is starting shortly, and in green to indicate that the physical workspace 28 is available. In some embodiments, the status bar 56 may blink to indicate that the multi-directional microphone 54 is operational, for example.

Some embodiments of the wall-mounted controller device 34 may include a backlight 80 to illuminate the controller device 34 in low-light conditions. In some embodiments, the controller device 34 may control a light 82 or other electronic device 82 in the physical workspace 28.

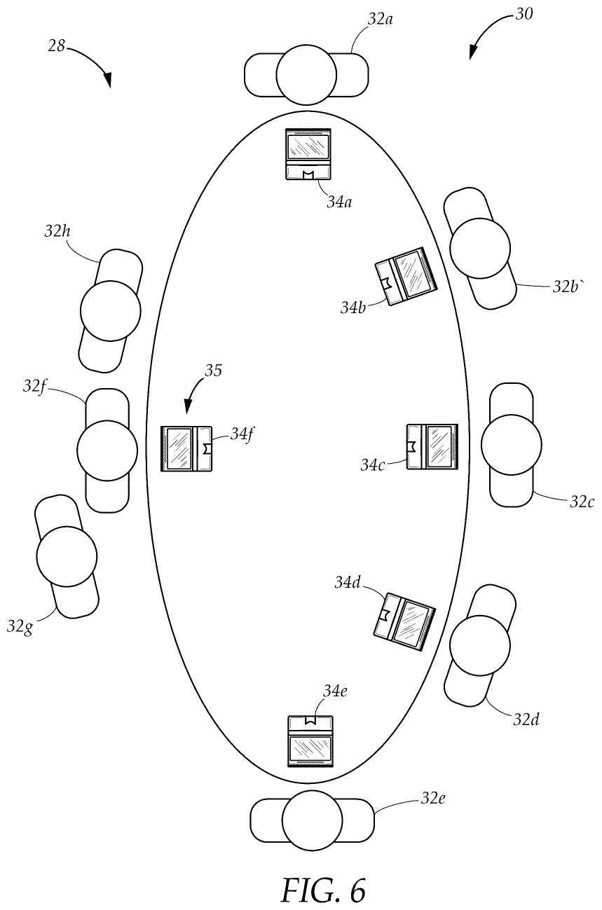

Referring now to FIG. 6, while also referring to FIGS. 1-3, in some embodiments, the interactive workspace integration system 30 includes multiple controller devices 34a-e corresponding to multiple users 32a-e, where each controller device 34a-e is controlled by a single user 32a-e. In some embodiments, at least one controller device 34f is simultaneously controlled by more than one user 32f-h.

In these and other embodiments, the microphones 54a-c of one or more controller devices 34a-f may perform audio amplification, echo cancellation, or other audio enhancement techniques on the sound input received to provide high-quality audio output to users 32a-h in the physical workspace 28 as well as to remote users in the virtual workspace. In some embodiments, one or more controller devices 34a-f may be configured to transmit audio signals that provide the sound for a local recording or remote video call (e.g., Zoom, Teams, WebEx).

In some embodiments, one of the controller devices 34a-f may be designated a master device 35 and configured to selectively control the other controller devices 34a-e. In some embodiments, the master device 35 may be configured to query each controller device 34a-f for a vote of the user 32a-h. Each of the other controller devices 34a-f may be configured to generate a vote in response to the query, and to transmit the vote to the master device 35. In some embodiments, the master device 35 may be configured to display the votes received from each of the controller device 34a-f, and/or tally the votes. In some embodiments, the status bar 56 (shown in FIG. 2) of each of the plurality of controller devices 34a-f may be configured to illuminate to indicate the vote. In some embodiments, the color of light emitted by the status bar 56 may communicate information regarding the vote.

For example, in certain embodiments, the status bar 56 may emit red light to indicate a vote of no, a green light to indicate a vote of yes, and a yellow light to indicate a vote of undecided. Of course, the status bar 56 may emit any color of light and/or combinations of colors to indicate any desired information. Similarly, in some embodiments, the status bar 56 may be configured to blink to indicate an undecided vote, to emit light continuously to indicate a vote of yes, and to power off to indicate a vote of no. In some embodiments, the status bar 56 may be configured to illuminate to indicate submission of the vote to the master device 35, while the vote itself may be maintained in secrecy.

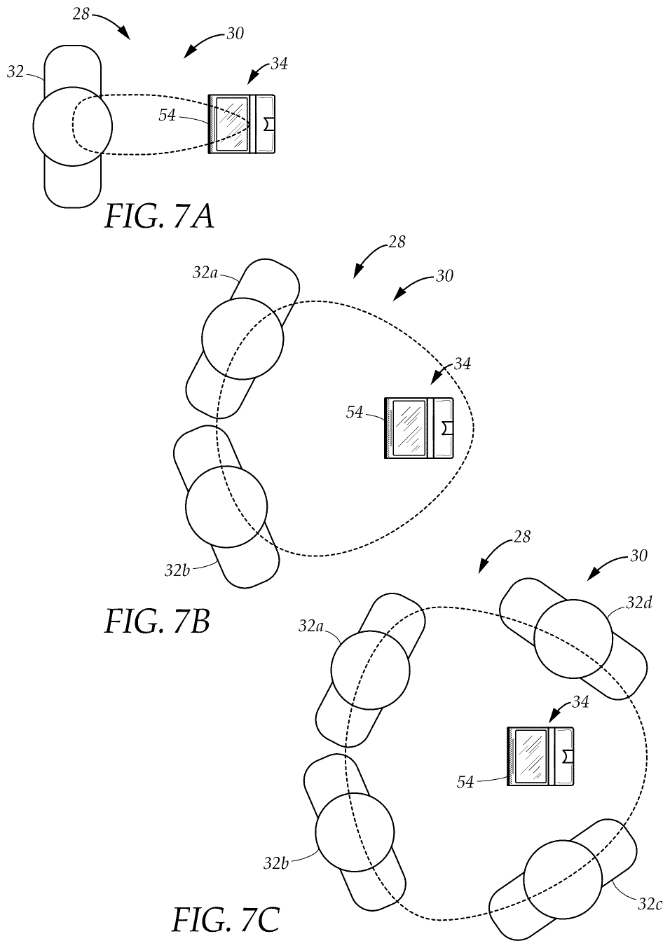

Referring now to FIGS. 7A-7C, in some embodiments, the controller device 34 may include an array of microphones 54 to capture and transmit directional sound in the physical workspace 28. In some embodiments, one or more of the microphones 54 is a digital microphone including a speaker and configured to create a beamform. In some embodiments, the controller device 34 may include a combination of software, hardware, and/or network protocols to capture and convert sound captured by the array of microphones 54 to high-fidelity digital audio signals for transmission over a network. In certain embodiments, the array of microphones 54 may deliver uncompressed, multi-channel, low-latency digital audio over an ethernet network using Layer 3 IP packets, for example. In other embodiments, the array of microphones 54 delivers compressed audio signals over a network.

In some embodiments, as shown in FIGS. 2 and 3, the array of microphones 54a-c is distributed around an outside perimeter of the base platform 36 to optimize sound localization and extraction from multiple speakers, for example. In some embodiments, for example, one microphone 54a is distributed across a front edge 38 of the base platform 36 and two microphones 54b, 54c are distributed across a back edge 40 of the base platform 36.

FIGS. 7A-7C illustrate various microphone pickup patterns involving an array of microphones 54 disposed on a single controller device 34. As shown, distribution of the microphones 54 around the controller device 34 may optimize high-fidelity sound capture and transmission in fluid situations where various users 32a-d are situated at various distances from the controller device 34 and in various arrangements relative to each other.

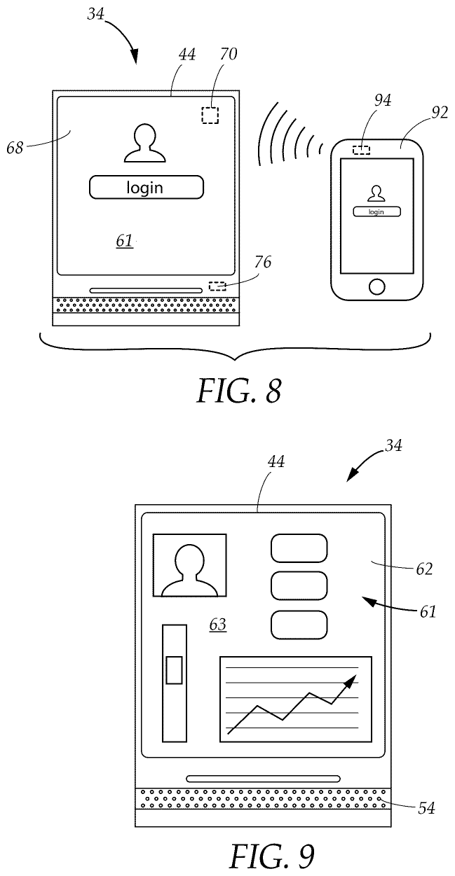

Referring now to FIG. 8, in some embodiments, the controller device 34 may include an internal web server 70 configured to display a configuration page 68 on the display panel 44. Some embodiments of the configuration page 68 may enable a user to enter login information including a name that may be displayed to other users, for example. In some embodiments, the configuration page 68 may also enable the user to select a color scheme or other display options. In some embodiments, the internal web server 70 may store the configuration page 68 locally such that the display screen 61 automatically displays the configuration page 68 upon powering on.

In some embodiments, the controller device 34 may communicate with a user mobile device 92 to receive configuration input from a user. Configuration input may include authorization information such as a username, password, touch identification, photo identification, or the like. In some embodiments, the controller device 34 may communicate with the user mobile device 92 via a wireless communication protocol such as Wi-Fi, near-field communication (NFC), or Bluetooth®. In some embodiments, for example, both the user mobile device 92 and the controller device 34 may include NFC ports 94, 76 such that configuration information and user input may be transmitted via NFC communication protocol.

Referring now to FIGS. 9-12, some embodiments of the display panel 44 have a display screen 61 to display a user control interface 62. In some embodiments, the user control interface 62 may be configured to receive user input including touch input via a touchscreen 63, voice input via one or more microphones 54, and/or input from a user input device 10 (as shown in FIG. 1) in communication with the controller device 34. In some embodiments, the user control interface 62 is configurable to display desired text and/or images and to customize the text and/or images in any desired color scheme, font scheme, theme, or the like. In some embodiments, for example, the user control interface 62 may be configured to display a name of the user and/or the user's seat assignment in the physical workspace 28, as shown in FIG. 6. In some embodiments, the user control interface 62 is further configurable to display or link to any desired webpages, news sources, social media, apps, and/or any other desired media or information.

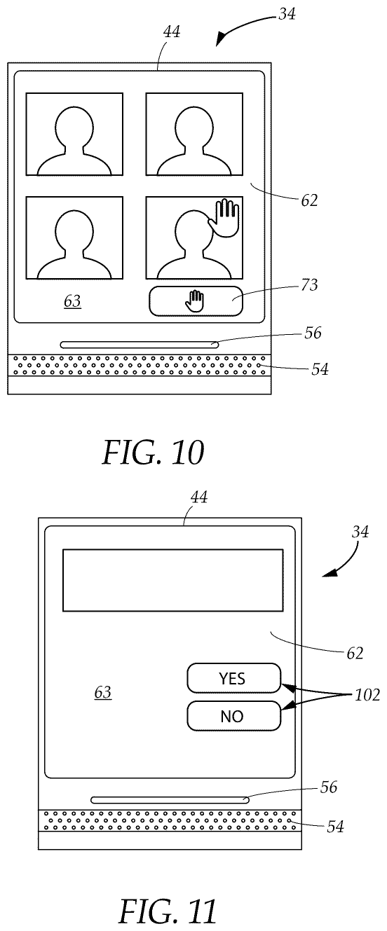

In certain embodiments, as shown in FIG. 10, the user control interface 62 may provide a raise hand function 73 to enable a user to indicate a desire to request the floor or speak. In some embodiments, the user control interface 62 may receive user input via a configurable button. In some embodiments, the user control interface 62 may be overlaid over the virtual workspace such that the button is displayed in connection with the image of the user.

In some embodiments, as shown in FIG. 11, the user control interface 62 may provide a vote function 102 to enable a user to lodge a vote in response to a verbal query or in response to a query from the master device 35 (shown in FIG. 6), for example. In some embodiments, the user control interface 62 may provide one or more buttons that the user may actuate to submit the vote. In other embodiments, the user control interface 62 may permit a slide to be moved along a continuum to indicate the vote. Of course, any user control interface 62 having any feature that may be selected or manipulated by a user to indicate the vote is contemplated herein. In some embodiments, as discussed above, the status bar 56 may be configured to illuminate in response to the vote.

In some embodiments, as illustrated in FIG. 12, the user control interface 62 may enable the user to actuate an assistive hearing function 104 such as sound amplification, noise cancellation, and/or echo cancellation, for example. In some embodiments, the user control interface 62 may enable the user to adjust a volume of the audio output. In some embodiments, the assistive hearing function 104 may translate voice input to text and the display screen 61 may display the text to the user.

In some embodiments, each controller device 34 may include an audio port 64 disposed on the base platform 36 and configured to couple to an audio output device 65. In some embodiments, the assistive hearing function 104 may be provided through the audio port 64 and/or audio output device 65. In some embodiments, the audio port 64 and/or audio output device 65 may communicate with the programmable processor 60 (as shown in FIG. 2) to provide the assistive hearing function 104.

Similarly, in some embodiments, the user control interface 62 may be configured to provide a language translation function. In some embodiments, the user control interface 62 may provide multiple selectable languages which may be selected via the touchscreen 63, for example. In some embodiments, the audio port 64 and/or audio output device 65 may process sound from the surrounding environment to output sound in the selected language. In some embodiments, the audio port 64 and/or audio output device 65 may communicate with the programmable processor 60 to process the sound.

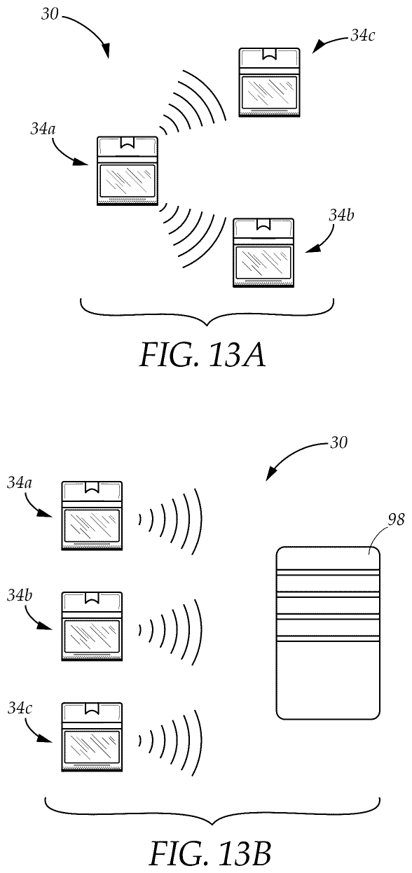

Referring to FIGS. 13A and 13B, in some embodiments, each controller device 34a-c may be interconnected with each other controller device 34a-c of the interactive workspace integration system 30. In this manner, as shown in FIG. 13A, each controller device 34a-c may broadcast or otherwise transmit information to all other controller devices 34a-c, or may selectively broadcast or otherwise transmit information to one or more selected controller devices 34a-c. In some embodiments, the controller devices 34a-c may transmit and/or receive the information between each other via a wired connection and/or a wireless communication protocol.

In some embodiments, as discussed above in FIG. 6, one of the controller devices 34a-c may be designated as the master device 35 and configured to control the other controller devices 34a-c. Other embodiments may include an independent hub device 98 configured to transmit information to each controller device 34a-c, receive information from each controller device 34a-c, and selectively control each controller device 34a-c.

In some embodiments, the hub device 98 may include a server, a mobile device, or another local or remote device in communication with each controller devices 34a-c. The hub device 98 may communicate with each controller device 34a-c via a wired or wireless connection. In some embodiments, the hub device 98 may be configured to query each of the controller devices 34a-c for a vote of the user, to receive the votes from the controller devices 34a-c, and to tally the votes.

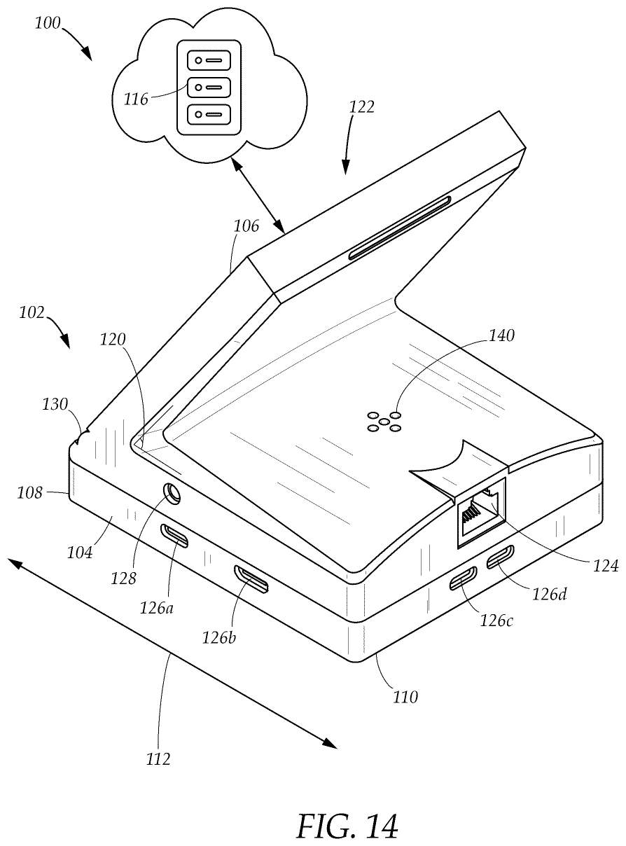

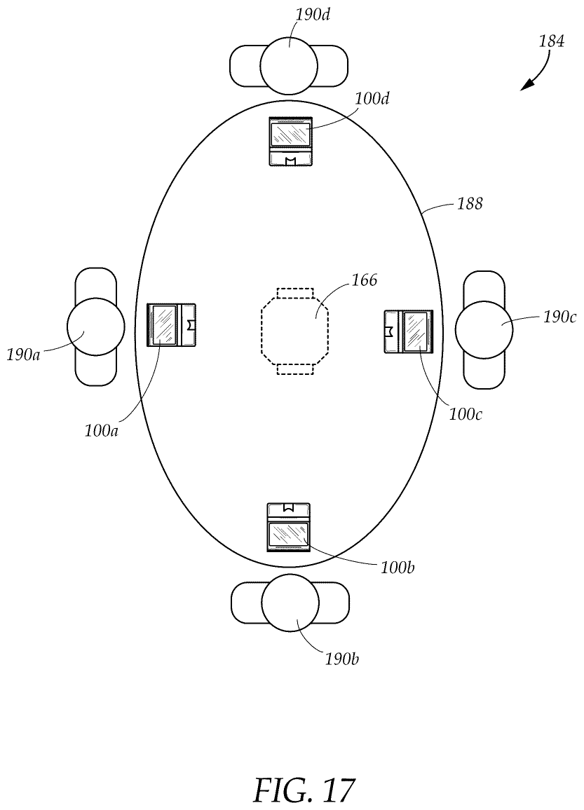

Referring now to FIGS. 14 and 17, in some embodiments, an interactive workspace apparatus 100 is configured to facilitate participation and collaboration in a physical workspace 188. In some embodiments, multiple interactive workspace apparatuses 100a-d are disposed within the physical workspace 188, and each interactive workspace apparatus 100a-d is configured to communicate with each other interactive workspace apparatus 100a-d via a wired or wireless connection.

In some embodiments, each of the interactive workspace apparatuses 100a-d corresponds to exactly one user 190a-d. In other embodiments, each interactive workspace apparatus 100a-d corresponds to more than one user 190a-d. One or more of the interactive workspace apparatuses 100a-d may be portable.

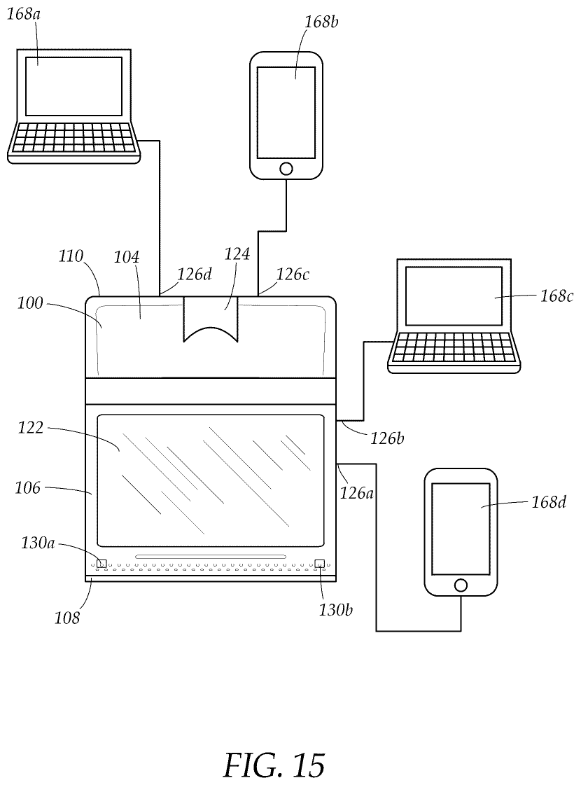

Referring now to FIGS. 14 and 15, the interactive workspace apparatus 100 may be designed to facilitate seamless communication in collaborative environments. In some embodiments, for example, each interactive workspace apparatus 100 features an advanced audio processing system that incorporates microphones 130a, 130b and integrated speaker(s) 140, along with state-of-the-art noise cancellation and/or voice-lift technology, as discussed in more detail below.

In some embodiments, the interactive workspace apparatus 100 is substantially similar in structure and/or function to the controller device 34 described above in relation to FIGS. 2 and 3. The interactive workspace apparatus 100 includes a housing 102 having a base platform 104 and display panel 106 (similar to base platform 36 and display panel 44 of FIG. 2), one or more microphones 130a, 130b (similar to microphones 54a-c of FIGS. 2 and 3), a speaker 140, and a programmable processor 116 (similar to programmable processor 60 of FIG. 3).

The base platform 104 may be substantially planar and may extend from a front edge 108 to a back edge 110 along a horizontal axis 112. The display panel 106 may extend upwards from the front edge 108 of the base platform 104 such that a fixed acute angle 120 is formed between the display panel 106 and the base platform 104. In some embodiments, the display panel 106 and the base platform 104 are monolithically formed as a single unit. In other embodiments, the display panel 106 is coupled to the base platform 104 via welding, bonding, adhesive, hinges, screws, nails, bolts, rivets, grommets, and or any other suitable mechanical fastening device or technique.

In some embodiments, the display panel 106 includes a display screen 122. In some embodiments, the display screen 122 is a touch screen configured to receive user input. The fixed acute angle 120 may cause the display screen 122 to be tilted upwards toward the user, thereby optimizing the user's view of the display screen 122 and facilitating user involvement and interaction therewith.

In some embodiments, the base platform 104 includes a network port 124, such as an ethernet port, to facilitate communication with other devices on a shared network. In addition to the ports 72, 74, 76 for remote communication as discussed above with respect to FIG. 3, the base platform 104 may further include various input and/or output ports 126a-d to enable communication with various peripheral devices 168a-d.

In some embodiments, an audio port 128 is disposed in the base platform 104 or other suitable portion of the housing 102. The audio port 128 may be configured to couple to a speaker, headphones, earphones, and/or any other suitable audio output device configured to process the at least one audio signal and/or emit sound in response thereto. In some embodiments, the audio output device is configured to provide audio amplification and/or language translation.

In some embodiments, the base platform 104 may include one or more dimensions selected to accommodate a desired arrangement of various ports 126a-d, 128, 124 For example, as shown in FIG. 14, in some embodiments, a height of the base platform 104 may be increased (relative to the base platform 36 shown in FIG. 2) to accommodate additional ports 126a-d.

Referring now to FIG. 15, in some embodiments, one or more ports 126a-d is configured to enable communication between the interactive workspace apparatus 100 and a desired peripheral devices 168a-d. Such ports 126a-d may be embodied as wired or wireless ports 126a-d and may include, for example, USB ports, USB-C ports, serial ports, Firewire ports, SCSI ports, parallel ports, Wi-fi ports, Bluetooth ports, IrDA ports, HDMI ports, and/or the like.

In some embodiments, one or more of the ports 126a-d is configured to enable communication between the interactive workspace apparatus 100 and one or more desired peripheral devices 168a-d, such as keyboards, mice, touchscreens, cameras, microphones, scanners, storage devices, laptop computing devices, tablet computing devices, desktop computing devices, display devices, speakers, printers, and/or any other suitable peripheral devices. In some embodiments, one or more of the ports 126a-d is configured to enable communication with one or more servers or other computing systems. In some embodiments, at least one of the ports 126a-d is configured to charge an associated peripheral device 168a-d during use.

In one embodiment, for example, a first port 126a is a USB-C input for display alt mode to be encoded as AV over IP to a decoder device to display a remote image. A second port 126b may be an HDMI port for the same purpose. A third port 126c may be a USB-C port configured to display output and USB 3.1 to connect to a secondary monitor for additional viewing space. A fourth port 126d may be a USB-C port configured to pass up to one hundred (100) watts of power to the first port 126a to charge a laptop computer that is plugged into it to encode its display output.

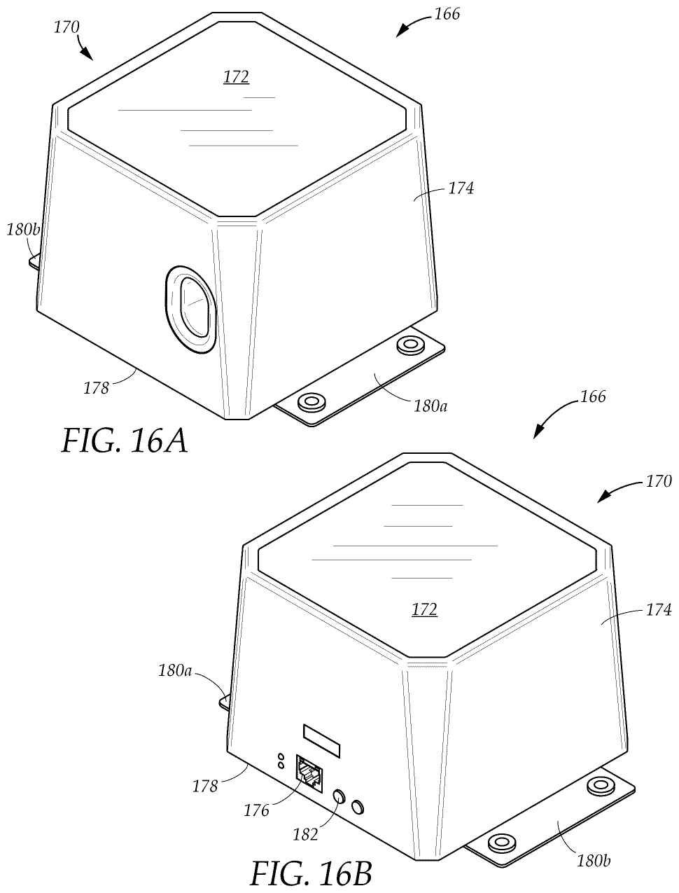

Referring now to FIGS. 16A and 16B, while also referring to FIG. 17, in some embodiments, one or more of the interactive workspace apparatuses 100a-d is communicatively coupled to a subwoofer device 166 via a wired or wireless connection. In some embodiments, the subwoofer device 166 is configured to add low-level audio signals to the audio output.

In one embodiment, the subwoofer device 166 includes a cabinet 170 having multiple side panels 174 extending substantially vertically between a bottom edge 178 and a substantially planar top surface 172. In some embodiments, at least one of the side panels 174 includes a network port 176 and/or other suitable ports to facilitate network-based and/or other electronic communication. The subwoofer device 166 may further include a power source (not shown) and/or various control knobs 182 or other suitable devices or mechanisms to provide audio control and customization.

In certain embodiments, the subwoofer device 166 is configured to rest on the ground or another supporting surface such that the top surface 172 is elevated and substantially parallel relative thereto. In other embodiments, the subwoofer device 166 is configured to be mounted under a table or other fixture in the physical workspace 188. In some embodiments, the subwoofer device 166 includes one or more stabilizing elements 180a, 180b to facilitate mounting the subwoofer device 166 to a suitable supporting surface as desired.

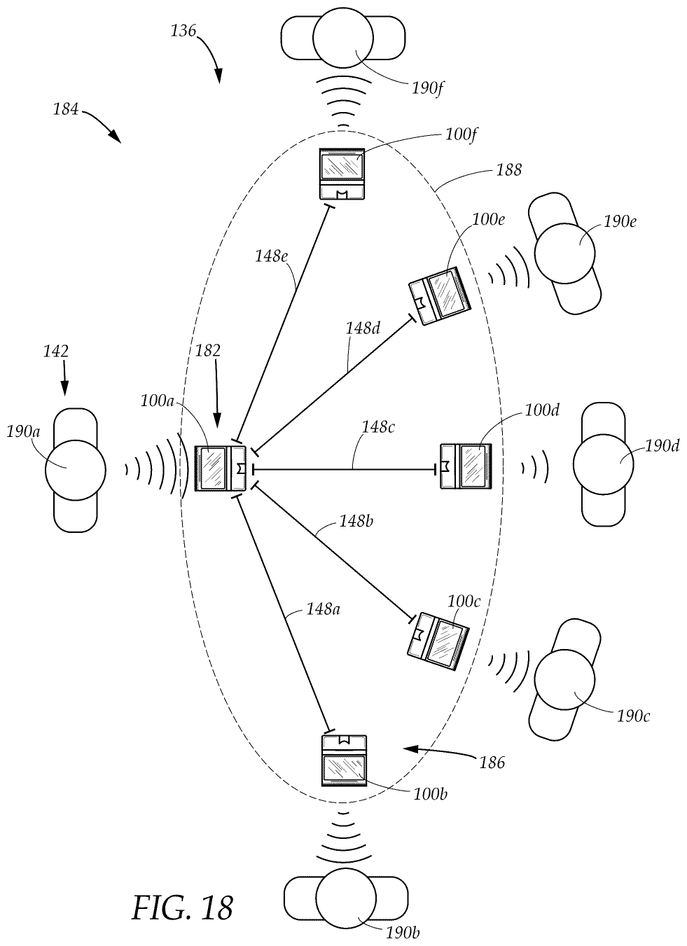

Referring now to FIG. 18, while still referring to FIG. 14, an interactive workspace system 184 to facilitate participation and collaboration in a physical workspace 188 may include multiple interconnected interactive workspace apparatuses 100a-f disposed at different corresponding locations within the physical workspace 188. For example, a first interactive workspace apparatus 100a may be disposed at a first location 182 and a second interactive workspace apparatus 100b interconnected to the first interactive workspace apparatus 100a may be disposed at a second location 186.

As previously discussed with respect to FIGS. 14 and 15, while still referring to FIG. 18, each of the interactive workspace apparatuses 100a-f may include a housing 102, a speaker 140, and one or more microphones 130a-b. The microphones 130a-b may be configured to capture sound from an audio source 142 (such as a user's 190a-f voice) and to convert the sound into an audio signal.

In certain embodiments, the programmable processor 60 is configured to convert one or more audio signals into transcribed text and to display the text on the display screen 122. The transcribed text may be stamped with a time, date, and/or name or other identity of the audio source 142 to provide a reference for later use. In some embodiments, the transcribed text is tagged with a highly accurate timestamp which may indicate the time at which the audio signal was received by the programmable processor 60 within a millisecond, for example.

In some embodiments, the transcribed text is displayed locally on the display screen 122 and/or remotely on one or more display screens 122 associated with other interactive workspace apparatuses 100a-f. In certain embodiments, the transcribed text is transmitted for display on a remote display screen or other peripheral device 168a-d in electronic communication with the programmable processor 60.

In certain embodiments, the transcribed text is tagged with the identity of the audio source 142 such as a number, name, location, or other suitable identifying information. In some embodiments, the programmable processor 60 is configured to combine the text corresponding to multiple speakers and/or audio sources 142 into a single unified document. The unified document may be displayed on the display screen 122 and/or transmitted to other interconnected interactive workspace apparatuses 100a-f for display and/or storage.

In certain embodiments, the transcribed text is stored locally on the interactive workspace apparatus 100a-f. In some embodiments, the transcribed text is electronically transmitted to a remote computer, cloud server, or other peripheral device 168a-d suitable for remote storage. In some embodiments, the remote storage device 168a-d is configured to receive the transcribed text from multiple interactive workspace apparatuses 100a-f and combine the text into a single transcript based on time stamps associated with the text feeds.

In this manner, transcriptions of multiple speakers' verbal and/or other audio-related contributions may be combined into a single document that displays the full interaction sequence between user's 190a-f in a collaborative meeting. In some embodiments, the unified document includes a timestamp corresponding to each interaction. In some embodiments, the unified document may thus facilitate enhanced coordination and/or playback accuracy for later review and/or documentation purposes.

In some embodiments, the programmable processor 60 is configured to utilize “word gating” to trigger certain operational settings or features of the interactive workspace apparatus 100a-f and/or other system 184 component(s). Unlike traditional microphone gating systems that rely simply on sound levels (which may lead to false triggers from non-speech sounds such as claps or coughs), the programmable processor 60 may only trigger an operational response of the interactive workspace apparatus 100a-f based on intelligible speech. Importantly, this feature may enhance audio tracking accuracy and minimize erroneous equipment activation and/or adjustments.

In some embodiments, the programmable processor 60 is configured to detect intelligible speech based on the timestamp associated with transcribed text, as discussed above. For example, in some embodiments, the programmable processor 60 only triggers an operational response in an interactive workspace apparatus 100a-f, peripheral device 168a-d, subwoofer 166, or other suitable system 184 component when the condition of a set number of intelligible words spoken within a set timeframe is met. In these and other embodiments, the programmable processor 60 may help to ensure that only meaningful verbal communication activates or adjusts a particular system 184 device, component, equipment, and/or operational feature thereof.

In certain embodiments, the programmable processor 60 triggers an operational response when a certain key trigger word or words are recognized. The key trigger word may be pre-programmed in the configuration settings of the programmable processor 60 to enable speech control of various interactive workspace apparatuses 100a-f and/or peripheral devices 168a-d. In other words, recognition of the key trigger word may allow the interactive workspace apparatus 100a-f to send a command to a specific targeted device to accomplish the desired outcome.

In one embodiment, for example, each interactive workspace apparatus 100a-f is associated with a particular seating location and/or location coordinates. Each location may correspond to one or more predetermined camera settings, or “presets”. The programmable processor 60 may be configured to utilize word gating to trigger camera presets such that a user 190a-f or other audio source 142 is brought clearly into view of the camera when speaking.

In some embodiments, one or more PTZ (Pan, Tilt, and Zoom) peripheral cameras may be aimed at various seating locations and may zoom in and out to focus on a user 190a-f or other audio source 142. Seating location coordinates associated with a particular interactive workspace apparatus 100a-f may be sent via RS-232, LAN, or any other suitable communication protocol, to quickly direct at least one of the cameras to focus on the user 190a-f of the interactive workspace apparatus 100a-f where intelligible words were detected. In certain embodiments, once fixed in a desired location, the camera or other peripheral device 168a-d is configured to store that location and/or associated information for later recall.

In some embodiments, the interactive workspace apparatus 100a-f is configured to translate transcribed speech into any of various languages in real time. In one embodiment, a user 190a-f selects their native language or other preferred language on the configuration page such that the associated interactive workspace apparatus 100a-f is configured to automatically convert displayed text to that language. In certain embodiments, the interactive workspace apparatus 100a-f is further configured to automatically convert displayed text to audio signals in the native or preferred language for output by the interactive workspace apparatus 100a-f or associated peripheral device 168a-d.

For example, one user 190a-f may speak English while another user 190a-f has selected Spanish as their preferred language. In some embodiments, the programmable processor 60 may transcribe the audio signals captured from the English speaker into text and then translate the transcribed English into Spanish for display on the Spanish user's 190a-f display screen 122. In some embodiments, the translated text is displayed on one or more remote interactive workspace apparatuses 100a-f. In certain embodiments, the translated text is translated back to speech again and the corresponding audio signals are output by the local interactive workspace apparatus 100a-f and/or one or more remote interactive workspace apparatuses 100a-f and or other peripheral devices 168a-d. This feature may facilitate seamless multilingual communication in collaborative environments.

Additionally, in some embodiments, the programmable processor 60 is configured to convert translated text back into audible speech. In other embodiments, the programmable processor 60 is configured to perform real-time, speech-to-speech translation. This feature may allow various users 190a-f to hear translated content in their native or other selected language through the speaker 140 or other audio output device 164 of their interactive workspace apparatus 100a-f. By integrating speech synthesis technology in this manner, the interconnected interactive workspace apparatuses 100a-f may facilitate multilingual conversations that feel natural or fluid.

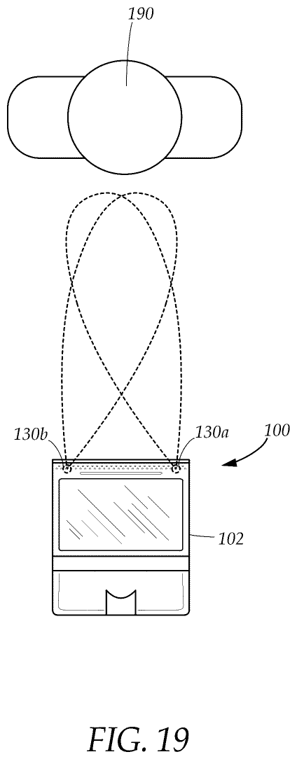

Referring now to FIG. 19, in some embodiments, the microphones 130a, 130b are strategically placed or disposed on the housing 102 to enable precise voice tracking and background noise suppression. In some embodiments, these microphones 130a, 130b leverage artificial intelligence (AI) to dynamically adjust the angle and/or focus on the associated user 190 or other audio source, ensuring clear audio capture without the need for intrusive hardware.

Referring again to FIGS. 18, 14, and 15, each of the interactive workspace apparatuses 100a-f may include a speaker 140 configured to receive at least one audio signal and to emit audio output or sound in response thereto. In certain embodiments, the speaker 140 is located at or towards a rear portion of the interactive workspace apparatus 100 such that the speaker 140 works in conjunction with the microphones 130a, 130b to provide localized audio output. This integration may help to ensure that the audio output is adapted to minimize feedback into the microphones 130a, 130b.

In some embodiments, each of the interactive workspace apparatuses 100a-f of the interactive workspace system 184 is configured according to a mix-minus configuration. In this manner, the audio output emitted from a particular interactive workspace apparatus 100a-f is amplified or otherwise adjusted based on a distance 148a-e between the interactive workspace apparatus 100 and a recipient interactive workspace apparatus 100a-f.

For example, in one embodiment, a first user 190a is associated with a first interactive workspace apparatus 100a located at a first location 182 within the physical workspace 188. The first interactive workspace apparatus 100a may be located at various distances 148a-e from other interactive workspace apparatuses 100b-f within the physical workspace 188. When the first user 190a speaks into the microphones 130a, 130b of the first interactive workspace apparatus 100a (thereby providing the audio source 142), the microphones 130a, 130b may capture the sound and convert it into one or more audio signals.

The speaker 140 associated with the first interactive workspace apparatus 100a may convert the audio signals to audio output for transmission to the interactive workspace apparatuses 100b-f associated with each of the other users 190b-f within the physical workspace 188. The audio output may be amplified or otherwise adjusted by the speaker 140 according to the mix-minus configuration 136. In other words, the audio output transmitted from the speaker 140 to each of the recipient interactive workspace apparatuses 100b-f may be amplified at different levels according to the distance 148a-e between the first interactive workspace apparatus 100a and the intended recipient interactive workspace apparatus 100b-f.

For example, the first user's 190a voice may be elevated by 1-2 dB for users 190b, 190f, located farther away and may be elevated by 0-1 dB for users 190c-e in closer proximity to the first user 190a. This may create an even “audio blanket” across the physical workspace 188, thereby ensuring that everyone hears the first user's 190a voice at a comfortable volume without straining or perceiving uneven sound distribution.

In some embodiments, each interactive workspace apparatus 100a-f operates independently to process and amplify the audio signals it receives. Each interactive workspace apparatus 100a-f may include a programmable processor (not shown) (such as a network-connected digital signal processor (DSP)) configured to analyze audio signals from each of the microphones 130a, 130b, adjust them relative to the other interactive workspace apparatus 100a-f, and transmit them to one or more intended recipient interactive workspace apparatuses 100a-f. In some embodiments, the programmable processor (not shown) processes audio streams from all interactive workspace apparatuses 100a-f using Dante, AS-67, or other suitable protocols. The programmable processor (not shown) may mix and amplify the audio signals relative to each unit's 100a-f physical position to facilitate precise sound distribution. In some embodiments, this feature ensures precise voice-lift tailored to individual locations rather than generalized zones.

In some embodiments, the programmable processor (not shown) is disposed within the housing 102 and operably coupled to at least one memory device. In some embodiments, at least a portion of the programmable processor (not shown) is remotely located relative to the housing 102. In some embodiments, the programmable processor (not shown) is configured to automatically configure the interactive workspace apparatus 100 according to the mix-minus configuration 136.

In certain embodiments, the programmable processor (not shown) utilizes innovative technologies such as ultrawideband, Bluetooth, or other suitable wireless communication devices to automatically measure distances 148a-e between various interactive workspace apparatuses 100a-f or units in real-time. In a portable configuration, ultrawideband technology may allow the interactive workspace system 184 to track unit 100a-f positions accurately and auto-adjust mix-minus configuration 136 parameters without manual intervention. This capability may be essential for dynamic environments where seating arrangements and/or device placements frequently change.

For static setups, a traditional calibration method using pink noise or pilot tones may be employed. The programmable processor (not shown) may facilitate manual adjustment based on signal levels measured at various locations.

In certain embodiments, a wireless communication device is operably coupled to the programmable processor (not shown) and configured to automatically determine the distance 148a-e. The wireless communication device may be an ultra-wideband (UWB) device, a Bluetooth Low Energy (BLE) device, a Radio Frequency Identification (RFID) device, a Wi-Fi RTT sensor, a Near Field Communication (NFC) sensor, or a Time-of-Flight (ToF) camera. This may enable automatic recalibration of the mix-minus configuration 136 when units 100a-f are moved, thereby potentially eliminating the need for manual setup during installation or operation.

In some embodiments, localized noise and/or echo cancellation is performed directly within each interactive workspace apparatus 100a-f, thereby ensuring fast and accurate suppression of unwanted sounds. This functionality may be particularly effective in environments with multiple overlapping conversations. In some embodiments, the microphones 130a, 130b are configured to filter the sound via angular beamforming techniques utilizing artificial intelligence (AI). For example, in some embodiments, these microphones 130a, 130b leverage AI to dynamically adjust the angle and focus on the audio source 142, thereby facilitating clear audio capture without the need for a traditional gooseneck microphone or other intrusive hardware.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, JavaScript, Smalltalk, C++ or the like and conventional procedural programming languages, such as the “C” programming language or similar programming languages. Other types of languages include XML, XBRL and HTML5. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. Each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flow diagrams depicted herein are just one example. There may be many variations to this diagram or the steps (or operations) described therein without departing from the spirit of the disclosure. For instance, the steps may be performed in a differing order and/or steps may be added, deleted and/or modified. All of these variations are considered a part of the claimed disclosure.

In conclusion, herein is presented an interactive workspace integration system and method. The disclosure is illustrated by example in the drawing figures, and throughout the written description. It should be understood that numerous variations are possible, while adhering to the inventive concept. Such variations are contemplated as being a part of the present disclosure.

What is claimed is:

1. An interactive workspace apparatus to facilitate participation and collaboration in a physical workspace, comprising:
a housing comprising a base platform and a display panel, wherein the base platform extends from a front edge to a back edge along a horizontal axis, wherein the display panel extends upwardly from the front edge towards the back edge at a fixed acute angle, and wherein the display panel comprises a display screen configured to receive user input;
at least one microphone coupled to the housing, wherein the at least one microphone is configured to capture sound from an audio source and to convert the sound into an audio signal;
a speaker coupled to the housing, wherein the speaker is configured to receive at least one audio signal and to emit an audio output in response thereto; and
a programmable processor disposed within the housing and operably coupled to at least one memory device, wherein the programmable processor is configured to convert the at least one audio signal into text and to display the text on the display screen.

2. The interactive workspace apparatus of claim 1, wherein the programmable processor is configured to transmit the text to another interconnected workspace apparatus.

3. The interactive workspace apparatus of claim 1, wherein the programmable processor is configured to tag the text with a timestamp.

4. The interactive workspace apparatus of claim 3, wherein the programmable processor is configured to tag the text with an identity of the audio source.

5. The interactive workspace apparatus of claim 4, wherein the programmable processor is configured to combine the text corresponding to multiple audio sources into a single unified document and display the single unified document on the display screen.

6. The interactive workspace apparatus of claim 1, wherein the programmable processor is configured to store the text.

7. The interactive workspace apparatus of claim 3, wherein the programmable processor is configured to trigger at least one predetermined operational setting of a camera disposed in the physical workspace in response to the text.

8. The interactive workspace apparatus of claim 1, wherein the programmable processor is configured to translate the text into a selected language to produce translated text, and wherein the programmable processor is configured to display the translated text on the display screen.

9. The interactive workspace apparatus of claim 8, wherein the programmable processor is configured to convert the translated text into at least one audio signal such that the audio output corresponds to the translated text.

10. An interactive workspace system to facilitate participation and collaboration in a physical workspace, comprising:
a first interactive workspace apparatus disposed in the physical workspace at a first location; and
a second interactive workspace apparatus interconnected to the first interactive workspace apparatus and disposed in the physical workspace at a second location, each of the first interactive workspace apparatus and the second interactive workspace apparatus comprising a mix-minus configuration to automatically adjust at least one audio signal in response to a distance between the first location and the second location, wherein each of the first interactive workspace apparatus and the second interactive workspace apparatus comprises:
a housing comprising a base platform and a display panel, wherein the base platform extends from a front edge to a back edge along a horizontal axis, wherein the display panel extends upwardly from the front edge towards the back edge at a fixed acute angle, and wherein the display panel comprises a display screen configured to receive user input;
at least one microphone coupled to the housing, wherein the at least one microphone is configured to capture sound from an audio source and to convert the sound into at least one audio signal;
a speaker coupled to the housing, wherein the speaker is configured to receive the at least one audio signal and to emit an audio output in response thereto, wherein the audio output is amplified based on a distance between the first location and the second location according to the mix-minus configuration; and
a programmable processor disposed within the housing and operably coupled to at least one memory device, wherein the programmable processor is configured to automatically adjust the amplification based on the mix-minus configuration, and wherein the programmable processor is further configured to convert the at least one audio signal into text and to display the text on the display screen.

11. The interactive workspace system of claim 10, wherein each of the first interactive workspace apparatus and the second interactive workspace apparatus comprises an internal web server configured to display a configuration page on the display screen, wherein the configuration page is configured to receive user input to customize a look and feel of the interactive workspace apparatus.

12. The interactive workspace system of claim 10, wherein the programmable processor is configured to tag the text with at least one of a timestamp and an identity of the audio source.

13. The interactive workspace system of claim 10, wherein the programmable processor is configured to combine the text corresponding to multiple audio sources into a single unified document and display the single unified document on the display screen.

14. The interactive workspace system of claim 13, wherein the programmable processor is configured to store the single unified document.

15. The interactive workspace system of claim 10, wherein the programmable processor is configured to trigger at least one predetermined operational setting of at least one of the first interactive workspace apparatus and the second interactive workspace apparatus based on the text.

16. The interactive workspace system of claim 12, wherein the programmable processor is configured to trigger at least one predetermined operational setting of a camera disposed in the physical workspace in response to at least one of the text and the timestamp.

17. The interactive workspace system of claim 10, wherein the programmable processor is configured to translate the text into a selected language to produce translated text, and wherein the programmable processor is configured to display the translated text on the display screen.

18. The interactive workspace of claim 17, wherein the programmable processor is configured to convert the translated text into at least one audio signal such that the audio output corresponds to the translated text.

19. The interactive workspace system of claim 10, wherein the programmable processor is configured to automatically determine a distance between the first location and the second location and to automatically configure each of the first interactive workspace apparatus and the second interactive workspace apparatus according to the mix-minus configuration.

20. The interactive workspace system of claim 19, wherein the programmable processor is configured to dynamically reconfigure the first interactive workspace apparatus and the second interactive workspace apparatus in response to a change in the distance.
